(19) United States
(12) Patent Application Publication
(10) Pub. No.: US 2023/0356330 A1
(43) Pub. Date: Nov. 9, 2023

(54) THREE-DIMENSIONAL PRINTING

(71) Applicant: Velo3D, Inc., Campbell, CA (US)

(72) Inventors: Benyamin Buller, Cupertino, CA (US); Zachary Ryan Murphree, San Jose, CA (US)

(21) Appl. No.: 18/135,829

(22) Filed: Apr. 18, 2023

Related U.S. Application Data
(63) Continuation of application No. 18/087,903, filed on Dec. 23, 2022.
Application No. 18/087,903 is a continuation of application No. 17/903,164, filed on Sep. 6, 2022, now abandoned.
Application No. 17/903,164 is a continuation of application No. 17/824,132, filed on May 25, 2022, now abandoned.
Application No. 17/824,132 is a continuation of application No. 17/675,196, filed on Feb. 18, 2022, now abandoned.
Application No. 17/675,196 is a continuation of application No. 17/519,979, filed on Nov. 5, 2021, now abandoned.
Application No. 17/519,979 is a continuation of application No. 17/380,363, filed on Jul. 20, 2021, now abandoned.
Application No. 17/380,363 is a continuation of application No. 17/227,868, filed on Apr. 12, 2021, now abandoned.
Application No. 17/227,868 is a continuation of application No. 17/134,676, filed on Dec. 28, 2020, now abandoned.
Application No. 17/134,676 is a continuation of application No. 17/020,714, filed on Sep. 14, 2020, now abandoned.
Application No. 17/020,714 is a continuation of application No. 15/886,544, filed on Feb. 1, 2018, now abandoned.

(51) Int. Cl. B23K 26/342; B33Y 30/00; B33Y 50/02; B23K 26/08; B33Y 70/00; B23K 26/12; B23K 26/142; B23K 26/14; B23K 26/082; B22F 10/28; B22F 10/77; B22F 12/30; B22F 12/49; B22F 12/60; B22F 12/70; B22F 10/32; B22F 10/322

(52) U.S. Cl. CPC B23K 26/342; B33Y 30/00; B33Y 50/02; B23K 26/083; B33Y 70/00; B23K 26/128; B23K 26/142; B23K 26/1438; B23K 26/123; B23K 26/0821; B22F 10/28; B22F 10/77; B22F 12/30; B22F 12/49; B22F 12/60; B22F 12/70; B22F 10/32; B22F 10/322; B22F 12/45

(57) ABSTRACT

The present disclosure describes three-dimensional (3D) printing apparatuses, processes, software, and systems for producing high quality 3D objects. Described herein are printing apparatuses that facilitate control of water vapor concentration during one or more printing operations.

### CROSS-REFERENCE

This application is a continuation of U.S. patent application Ser. No. 18/087,903 filed Dec. 23, 2022, which is a continuation of U.S. patent application Ser. No. 17/903,164 filed Sep. 6, 2022, which is a continuation of U.S. patent application Ser. No. 17/824,132 filed May 25, 2022, which is a continuation of U.S. patent application Ser. No. 17/675,196 filed Feb. 12, 2022, which is a continuation of U.S. patent application Ser. No. 17/519,979 filed Nov. 5, 2021, which is a continuation of U.S. patent application Ser. No. 17/380,363 filed Jul. 20, 2021, which is a continuation of U.S. patent application Ser. No. 17/227,868 filed Apr. 12, 2021, which is a continuation of U.S. patent application Ser. No. 17/134,676 filed Dec. 28, 2020, which is a continuation of U.S. patent application Ser. No. 17/020,714 filed Sep. 14, 2020, which is a continuation of U.S. patent application Ser. No. 15/886,554 filed Feb. 1, 2018, all of which are entirely incorporated herein by reference.

### BACKGROUND

Three-dimensional (3D) printing is a process for making objects by sequential deposition of material, at times, under computer control. Often, the objects are made sequentially by forming multiple layers of material that are joined together to form a 3D object having desired dimensions. A variety of materials can be used, including metal, ceramic, or polymeric materials. 3D printing systems can vary in their methods of forming the multiple layers, such as by melting, sintering, softening, hardening, or liquifying. The quality of a 3D object can depend on the processing conditions for printing the 3D object. For example, the type of material, the temperatures used to perform the joining, as well as atmospheric conditions surrounding the 3D object during its formation, may influence characteristics of the 3D object. Currently needed are improved 3D printing systems and methods for forming high quality 3D objects, at a competitive cost.

### SUMMARY

In one aspect, systems, apparatuses, methods, controllers, and/or non-transitory computer-readable media (e.g., software) for printing three-dimensional objects is described.

In another aspect, an apparatus for printing a three-dimensional object comprises: a platform configured to support a powder bed comprising powder; a laser configured to generate a laser beam that melts at least a portion of the powder bed to a molten material as part of the three-dimensional object; a layer forming device configured to form a planar layer of the powder as part of the powder bed, which layer forming device comprises a blade or a roller configured to translate in a first direction over an exposed surface of the powder bed to planarize the exposed surface of the powder bed; an elevator operationally coupled with the platform, wherein the elevator comprises an actuator configured to translate the platform in a second direction substantially perpendicular to the first direction; a processing chamber having walls that at least partially define an internal volume, which processing chamber is configured to enclose at least the exposed surface of the powder bed within an atmosphere during the printing, wherein at least one wall of the processing chamber comprises a window that is configured to permit at least a portion of the laser beam to pass therethrough to the internal volume; a galvanometer scanner configured to translate the laser beam across the exposed surface of the powder bed in accordance with a path, which galvanometer scanner is configured to move the laser beam within a processing cone region of the internal volume of the processing chamber; a gas flow system comprising one or more inlet openings and one or more outlet openings, which gas flow system is configured to provide a flow of gas into the internal volume from the one or more inlet openings to the one or more outlet openings, which gas flow system is coupled with a conduit that directs the flow of gas out of the internal volume via the one or more outlet openings, wherein the gas flow system is configured to maintain a water vapor concentration of the atmosphere characterized as having a dew point temperature of at least about −40 degrees Celsius (° C.) at a location that is exposed to the flow of gas, which location is (i) in the one or more outlet openings, (ii) in the internal volume of the processing chamber and outside of the processing cone region, or (iii) in the conduit and downstream from the one or more outlet openings, wherein the water vapor concentration is associated with incorporation of oxygen in the three-dimensional object; and one or more controllers operationally coupled with the elevator, the layer forming device and the galvanometer scanner, which one or more controllers is configured to direct (a) the elevator to translate the platform in the second direction, (b) the layer forming device to translate in the first direction, and (c) the galvanometer scanner to direct the laser beam at the exposed surface of the powder bed in accordance with the path.

In some embodiments, the one or more inlet openings is operationally coupled with an non-reactive gas source, which non-reactive gas source is configured to provide an non-reactive gas as part of the flow of gas, which non-reactive is with the molten material during the printing. In some embodiments, the one or more inlet openings is operationally coupled with an inert gas source, which inert gas source is configured to provide an inert gas as part of the flow of gas. In some embodiments, the inert gas has no more than about five parts-per million of water by volume. In some embodiments, water vapor is incorporated with the inert gas as part of the flow of gas. In some embodiments, at least a portion of the water vapor is from one or more of (I) the powder bed, (II) an external environment, (Ill) internal walls contacting the flow of gas, and (IV) components within the internal volume. In some embodiments, the internal walls are of the processing chamber. In some embodiments, wherein the location is in an outlet portion of the conduit, wherein the system further comprises an inlet portion of the conduit operatively coupled to the inlet. In some embodiments, the internal walls are of the inlet conduit and/or outlet conduit. In some embodiments, the flow of gas further modifies a concentration of gas-borne debris within the internal volume. In some embodiments, the location is at most about five centimeters from the one or more outlet openings. In some embodiments, in the one or more outlet openings comprises on a wall of the processing chamber or the conduit. In some embodiments, the dew point temperature is at least about −25° C. In some embodiments, the dew point temperature is at least about −4° C. In some embodiments, the dew point temperature ranges from about −40° C. to about −25° C. In some embodiments, the dew point temperature ranges from about −25° C. to about 1° C. In some embodiments, the dew point temperature ranges from about −4° C. to about 5° C. In some embodiments, a temperature of the atmosphere ranges from about 20° C. to about 50° C., and wherein the water vapor concentration is characterized as having a relative humidity at the location of at least about 1 percent (%). In some embodiments, the relative humidity is at least about 5%. In some embodiments, the relative humidity is at least about 20%. In some embodiments, the relative humidity ranges from about 1 percent (%) to about 50%. In some embodiments, the relative humidity ranges from about 1% to about 25%. In some embodiments, downstream from the one or more outlet openings is in relation to a direction of the flow of gas. In some embodiments, the location is within the conduit upstream of one or more filters. In some embodiments, the water vapor concentration is associated with incorporation of oxygen within the molten material. In some embodiments, the powder comprises elemental metal or metal alloy. In some embodiments, the three-dimensional object comprises a metal alloy, and the water vapor concentration causes oxygen to become incorporated within the metal alloy. In some embodiments, the metal alloy comprises iron or nickel. In some embodiments, the three-dimensional object comprises a titanium alloy, and wherein the water vapor concentration causes oxygen to become incorporated within the titanium alloy. In some embodiments, the titanium alloy comprises alpha titanium, beta titanium, or alpha-beta titanium. In some embodiments, the titanium alloy comprises aluminum and vanadium. In some embodiments, the titanium alloy comprises a Ti—6Al—4V alloy. In some embodiments, the location is outside of a region of the internal volume between (I) the window and (II) the exposed surface of the powder bed or the exposed surface of the platform. In some embodiments, the processing cone region comprises regions within the internal volume that the laser beam may occupy when impinging upon the powder bed and/or a portion of the three-dimensional object. In some embodiments, wherein the apparatus further comprises a heating element that is configured to heat the powder bed (e.g., before, after, and/or during the 3D printing). In some embodiments, the heating element is disposed in a build module that is coupled to the processing chamber during the printing. In some embodiments, the heating element comprises a plate that is coupled to the platform. In some embodiments, the elevator is disposed in the build module. In some embodiments, the heating element is actively heated. In some embodiments, the water vapor concentration is associated with printing the three-dimensional object having a porosity of about 1% by volume or less. In some embodiments, the porosity is measured within the interior and/or the surface of three-dimensional object. In some embodiments, the porosity is measured within any volume of the three-dimensional object. In some embodiments, the water vapor concentration is associated with printing the three-dimensional object having a surface roughness of about 50 micrometers or less. In some embodiments, the surface roughness is measured on any exterior surface of the three-dimensional object. In some embodiments, the flow of gas is directed at the exposed surface of the powder bed. In some embodiments, the flow of gas is directed that is parallel or substantially parallel to the exposed surface of the powder bed. In some embodiments, during the printing, the apparatus is configured to form at least about five (5) cubic centimeters of the molten material per hour. In some embodiments, during the printing, the apparatus is configured to melt from about 1 to about 50 cubic centimeters of the molten material per hour. In some embodiments, the one or more controllers is operationally coupled with the gas flow system, which one or more controllers is configured to direct the gas flow system to provide the flow of gas within the processing chamber. In some embodiments, at least two of (a), (b), and (c) are directed sequentially. In some embodiments, at least two of (a), (b), and (c) are directed in parallel. In some embodiments, the one or more controllers is operationally coupled with the gas flow system, which one or more controllers is configured to control a velocity of the flow of gas. In some embodiments, the control (e.g., of aspects of the flow of gas) is in real time during the printing of the three-dimensional object. In some embodiments, the gas flow system causes a turbulent movement of gas within the internal volume of the processing chamber. In some embodiments, the turbulent movement of gas comprises a cyclic movement, a backflow, a vortex, or a chaotic movement of gas. In some embodiments, the window is within a recessed portion of the processing chamber. In some embodiments, the gas flow system is configured to provide the flow of gas at a constant velocity or a substantially constant velocity within the processing chamber during at least the melting of the at least the portion of the powder bed. In some embodiments, the flow of gas has a velocity ranging from about 0.2 meters per second (m/s) to about 2 m/s. In some embodiments, the one or more outlet openings are operatively couple to, or comprise: a perforated plate, a screen, a mesh, or a gas permeable material. In some embodiments, the gas permeable material comprises a block or a slab of material. In some embodiments, the gas permeable material comprises a material comprising (e.g., random) passages, voids (e.g., bubbles), and/or holes. In some embodiments, the gas permeable material comprises elemental metal, metal alloy, ceramic, an allotrope of elemental metal, a polymer, or a resin. In some embodiments, the flow of gas has a peak horizontal velocity at a distance of about 15 to about 100 millimeters (mm) above the exposed surface of the powder bed. In some embodiments, the one or more inlet openings is part of an inlet region coupled to a ceiling wall of the processing chamber, and wherein the one or more outlet openings is part of an outlet region coupled to a side wall or a floor of the processing chamber. In some embodiments, the one or more inlet openings is part of an inlet region coupled to a first side wall of the processing chamber, and wherein the one or more outlet openings is part of an outlet region coupled to a second side wall of the processing chamber. In some embodiments, the laser is configured to generate the laser beam having an average power density ranging from about 100 to about 30,000 per centimeter squared (kW/cm²), which power density is measured at the exposed surface of the powder bed. In some embodiments, a distance between an internal surface of the window and the exposed surface of the powder bed ranges from about 10 and about 100 centimeters (cm). In some embodiments, a power of the laser is configured to be modified during the printing. In some embodiments, wherein the apparatus further comprises an optical system configured to modify at least one characteristic of the laser beam, wherein the optical system is configured to focus or defocus the laser beam at the exposed surface of the powder bed. In some embodiments, wherein the apparatus further comprises a build module removably coupled to the processing chamber during the printing, wherein the processing chamber and the build module are configured to decouple from each other after the printing of the three-dimensional object. In some embodiments, decoupling the processing chamber and the build module causes an external atmosphere to enter the internal volume of the processing chamber. In some embodiments, decoupling the processing chamber and the build module increase the water vapor concentration at the location. In some embodiments, decoupling the processing chamber and the build module decreases the water vapor concentration at the location. In some embodiments, during the printing is at least during melting of the at least the portion of the powder bed to the molten material. In some embodiments, during the printing comprises during forming of the planar or substantially planar layer of the powder. In some embodiments, the apparatus comprises: (I) multiple lasers, (II) multiple windows, (Ill) multiple galvanometer scanners, or (IV) any combination of (I), (II) and (III). In some embodiments, the window is at least about 85% transparent to the laser beam. In some embodiments, the window comprises silica or quartz. In some embodiments, a pressure of the atmosphere within the internal volume is equal to or substantially equal to a pressure of an atmosphere external to the processing chamber. In some embodiments, a pressure of the atmosphere within the internal volume ranges from about 50 kPa below to about 50 kPa above an ambient pressure. In some embodiments, a temperature of the atmosphere within the internal volume ranges from about 5 degrees Celsius (° C. to) about 100° C. during the printing. In some embodiments, a temperature of the atmosphere ranges from about 20 degrees Celsius (° C. to) about 50° C. during the printing. In some embodiments, the galvanometer scanner is external to the internal volume of the processing chamber. In some embodiments, the conduit directs the flow of gas from the one or more outlet openings to the one or more inlet openings. In some embodiments, the conduit is part of or coupled with a gas recycling system. In some embodiments, the location (ii) and/or (iii) comprises the outlet opening. In some embodiments, the location (iii) is from the outlet opening to a filter disposed along the conduit. In some embodiments, the location (ii) is in the internal volume of the processing chamber, and outside of a volume having (1) a first face that is the exposes surface or the powder bed or the platform, (2) a second face identical to the first face in shape and size and parallel thereto, and (3) a third face connecting the first and the second face, which third face is perpendicular to the first face and to the second face.

Another aspect of the present disclosure provides a method for using the apparatuses disclosed herein (e.g., according to its intended function).

In another aspect, an apparatus for printing one or more 3D objects comprises a controller that is programmed to direct a mechanism used in a 3D printing methodology to implement (e.g., effectuate) any of the method and/or functions of the apparatuses disclosed herein, wherein the controller is operatively coupled to the mechanism.

In another aspect, a computer software product, comprising a non-transitory computer-readable medium in which program instructions are stored, which instructions, when read by a computer, cause the computer to direct a mechanism used in the 3D printing process to implement (e.g., effectuate) any of the method and/or functions of the apparatuses disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods and/or functions of the apparatuses disclosed herein.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods and/or functions of the apparatuses disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically illustrates a section view of a portion of a three-dimensional (3D) printer;

FIG. 2 schematically illustrates a section view of a portion of a 3D printer;

FIG. 3 schematically illustrates a section view of a portion of a 3D printer;

FIG. 4 schematically illustrates a section view of a portion of a 3D printer;

FIG. 5 illustrates a graph indicating gas flow parameters;

FIG. 6 schematically illustrates a section view of a portion of a 3D printer; and

FIG. 7 schematically illustrates a computer system.

The figures and components therein may not be drawn to scale. Various components of the figures described herein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

The present disclosure provides apparatuses, systems and methods for controlling aspects of printing 3D objects. In some embodiments, the apparatuses, systems and methods are used to control an amount of moisture within an enclosure during printing of a 3D object. Methods include controlling gas flow within a processing chamber, including in a region over an exposed surface of a powder bed. The gas flow can provide an atmosphere for transforming (e.g., melting) the powder using an energy beam (e.g., laser beam). The atmosphere may have a prescribed level of water vapor. In some cases, the prescribed level of water vapor is associated with incorporation of oxygen within the 3D object. In some embodiments, the prescribed level of water vapor is associated with incorporation of oxygen within titanium alloys. The prescribed level of water vapor can be used to print one or more 3D objects with low porosity and/or low surface roughness. In some embodiments, the printing systems are configured to print 3D object having a porosity at most about 1% by volume and/or a surface roughness (Ra) of at most about 50 micrometers.

The term “operatively coupled” or “operatively connected” refers to a first mechanism that is coupled (or connected) to a second mechanism to allow the intended operation of the second and/or first mechanism. The term “configured to” refers to an object or apparatus that is (e.g., structurally) configured to bring about a result.

Terms such as “a,” “an” and “the” are not intended to refer to only a singular entity, but include the general class of which a specific example may be used for illustration. The terminology herein is used to describe specific embodiments, but their usage does not limit the specified embodiments.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

Fundamental length scale (abbreviated herein as “FLS”) can refer herein as to any suitable scale (e.g., dimension) of an object. For example, a FLS of an object may comprise a length, a width, a height, a diameter, a spherical equivalent diameter, or a diameter of a bounding sphere. In some cases, FLS may refer to an area, a volume, a shape, or a density.

The present disclosure provides three-dimensional (3D) printing apparatuses, systems, software, and methods for forming 3D objects. A powder, as understood herein, is a granular material before it has been melted using a printing operation (also referred to as “printing”). During printing can refer to the time frame in which one or more 3D objects are being formed. During printing can include during formation of one or more layers of powder and/or during transforming (e.g., melting) of the powder. During melting can refer to the time frame in which a laser beam is impinging on the powder and/or transforming (e.g., melting) the powder to a molten state. The melting can be complete or partial melting. Reference is made herein as to a “build,” which can refer to the one or more 3D objects being printed on (e.g., above) a build platform. During a build can refer to the time frame for printing one or more 3D objects on (e.g., above) a build platform. In some cases, the printing apparatus is continuously in operation (e.g., printing a portion of the one or more 3D objects and/or forming a layer of powder) during a build. In some cases, one or more operations of the printing apparatus is/are paused (e.g., interrupted) during a build. The printer may be referred herein as a “printing system” or a “printing apparatus.”

In some embodiments, the size of the particles of the powder range from about 10 micrometers (□m) to about 50 □m in fundamental length scale (e.g., diameter). The printing can include sequentially melting multiple sequentially deposited layers of powder respectively, where one layer of melted (molten) material fuses with an adjacent layer to form at least a portion of a 3D object. Some of the printing techniques described herein are in accordance with selective laser melting (SLM), selective heat sintering (SHS), or selective laser sintering (SLS) techniques. The powder can be made of any suitable material. For example, the powder may comprise an elemental metal or metal alloy. In some embodiments, the material comprises a metal, such as steel (e.g., stainless steel), aluminum, aluminum alloys, nickel, nickel alloys (e.g., Inconel), titanium and/or titanium alloys.

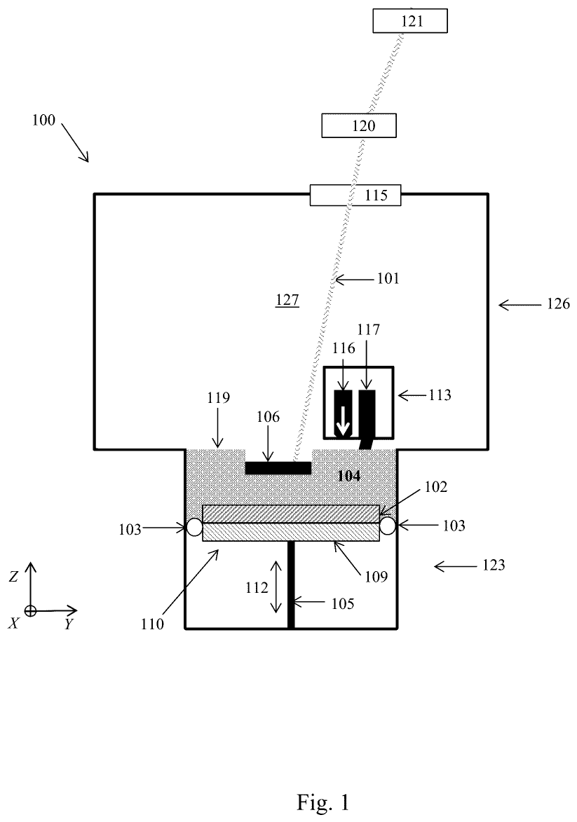

The printing system may include an enclosure. FIG. 1 shows a cross-section side view of an example printer having an enclosure 100, which includes a processing chamber 126 and a build module 123 that is configured to accommodate the powder bed 104. The processing chamber has walls that at least partially define an internal volume 127. The internal volume of the processing chamber can accommodate a laser beam 101 generated by a laser 121. In some cases, the laser beam is directed through a window 115 that is coupled to at least one wall of the processing chamber. The window may be referred herein as an “optical window.” In some embodiments, the window is coupled to a ceiling (e.g., top wall) of the processing chamber. The window can be configured to permit at least a portion of the laser beam to pass therethrough to the internal volume of the processing chamber. The window 115 can be made of any suitable material. In some embodiments, the window is made of a material that is at least about 85%, 90%, 95% or 99% transparent to certain wavelengths of the laser beam. In some cases, the window is comprised of a silica (e.g., fused silica) or quartz (e.g., fused quartz). The laser beam is directed at an exposed surface 119 of the powder bed to melt at least a portion of the powder. The impinged-on portion of the powder bed that has been melted, subsequently cools to a hardened material 106 as part of the 3D object. The 3D object may be anchored to the platform (e.g., comprising a base such as 102), or be suspended anchorlessly in the powder bed (e.g., 104). Any of the enclosure parts and/or platform may comprise elemental metal, metal alloy, or ceramic (e.g., as described herein). In some embodiments, during the printing, the printer is configured to form at least about 1 cubic centimeters per hour (cm³/hr), 5 cm³/hr, 10 cm³/hr, 20 cm³/hr, 30 cm³/hr, 40 cm³/hr, 50 cm³/hr, or 100 cm³/hr of the molten material. The printer may be configured to form molten material at a rate between any of the aforementioned values (e.g., from about 1 cm³/hr to about 100 cm³/hr, from about 1 cm³/hr to about 30 cm³/hr, from about 30 cm³/hr to about 100 cm³/hr, or from about 1 cm³/hr to about 50 cm³/hr).

The walls of the processing chamber can be configured to enclose at least the exposed surface (e.g., 119) of the powder bed (e.g., 104) within an atmosphere while the melting process occurs. For example, the walls of the processing chamber can at least partially isolate the internal atmosphere from an external environment (e.g., ambient environment). In some cases, the external environment is the environment of a room in which the printer is located. In some cases, the processing chamber is further enclosed within another environment different than the external environment. For example, the processing chamber, build module and/or additional chambers (e.g., unpacking station) may be enclosed within a larger enclosure that has its own internal environment. In some embodiments, the atmosphere in the processing chamber includes one or more inert gases, such as argon and/or nitrogen. In some cases, the walls of the processing chamber may function to protect users of the printer from contents of the atmosphere, laser beam, debris, and/or the powder, from users of the printer. For example, the walls may provide protection against the laser beam and/or any combustible material.

The laser can be any suitable type of laser, such as a fiber laser, a solid-state laser, or a diode laser. In some embodiments, the laser is configured to generate an optical power output (laser power) ranging from about 100 Watts to about 1,000 Watts. In some embodiments, the laser power is modified (e.g., increased and/or decreased) during a printing operation. The laser power modification can be controlled manually and/or automatically (e.g., using a controller). In some embodiments, the laser may be configured to generate a laser beam having a power density on (e.g., at the exposed surface of) the powder bed ranging from about 100 kilowatts per centimeter squared (kW/cm²) to about 30,000 kW/cm². In some embodiments, the laser is configured to generate a laser beam having peak wavelength in a range of about 800 nm to about 1,500 nm. In some embodiments, the laser is configured to generate a laser beam having a spot size on the powder bed having a diameter ranging from about 50 micrometers (□m) to about 500 □m.

Characteristics and/or movement of the laser beam(s) can be modified by an optical system that includes one or more optical elements (e.g., 120). The optical system may be situated inside or outside of the enclosure (e.g., processing chamber). In some embodiments, the optical elements and/or the laser are enclosed within a separate chamber (e.g., external) (e.g., adjacent) to the processing chamber and/or part of the enclosure of the printer). The optical elements can include one or more scanners (e.g., galvanometer scanners), polygons, mechanical stages (e.g., X-Y stages), piezoelectric devices, gimbles, mirror, lenses, windows, beam splitters, and/or prisms. The scanners can be configured to direct (e.g., by deflection) the laser beam across the exposed surface of the powder bed in accordance with a (e.g., predetermined) path. In some embodiments, the scanners are configured to provide scan speeds up to about 5 meters per second (m/s). The laser path can include one or more hatches. The laser path can be in accordance with a stripe pattern, island pattern and/or chessboard pattern. The laser beam scanning may be unidirectional, bidirectional, spiral and/or double scan. The window (e.g., 115) may be considered an optical element in that it allows transmission of laser beam (e.g., 101) into the internal volume (e.g., 127) of the processing chamber. In some cases, the optical system is configured to focus or defocus the laser beam at the exposed surface of the powder bed (e.g., as dictated by one or more controllers).

The enclosure may include one or more build modules (e.g., 123). A build module can be removably coupled with the processing chamber or be integrally coupled to the processing chamber. The build module can include an internal volume configured to enclose at least a portion of a platform (e.g., 110) (also referred to herein as a “build platform”), which is configured to support the powder bed. In some cases, the platform includes a base (e.g., 102) and/or a substrate (e.g., 109). In some embodiments, the surface of the platform that supports the powder bed has an area ranging from about 100 square centimeters (cm²) to about 10,000 cm². The internal volume of the build module can be configured to enclose at least a portion of an elevator (e.g., 105). The elevator can be operationally coupled to the platform and configured to move (e.g., vertically translate) (e.g., 112) the platform. In some cases, the elevator is configured to translate the platform in a direction that is (e.g., substantially) perpendicular to the direction that the layer forming device translates. In some embodiments, the platform is configured to translate in vertical steps ranging from about 20 micrometers (□m) to about 500 □m. In some embodiments, the platform is configured to support a powder bed having a height (e.g., in Z direction of FIG. 1) ranging from about 100 millimeters (mm) to about 1,000 mm. In some embodiments, one or more seals (e.g., 103) enclose the powder in a selected area within the build chamber (e.g., away from the elevator). The elevator may comprise an actuator (e.g., a motor).

The build module may be removably engageable with the processing chamber (e.g., configured to engage and disengage). For example, the build module may be coupled (e.g., engaged) with the processing chamber during a printing operation to at least partial isolate the internal volume of processing chamber from the external atmosphere. The coupling may cause atmospheres within each of the processing chamber and the build module to merge. The coupling may be facilitated using one or more coupling mechanisms, such as clamp(s), bolt(s), screw(s) and/or seal(s) (e.g., o-ring(s)). The build module and the processing chamber may be decoupled (e.g., disengaged) from each other (e.g., after a printing operation). In some cases, the decoupling opens the internal volume of the processing chamber and/or the build module to the external atmosphere. In some cases, the decoupling exposes the powder and/or 3D object(s) to the external atmosphere. In some embodiments, the build module and/or the processing chamber (each) includes a shutter that isolates the atmosphere within the build module and/or the processing chamber upon decoupling.

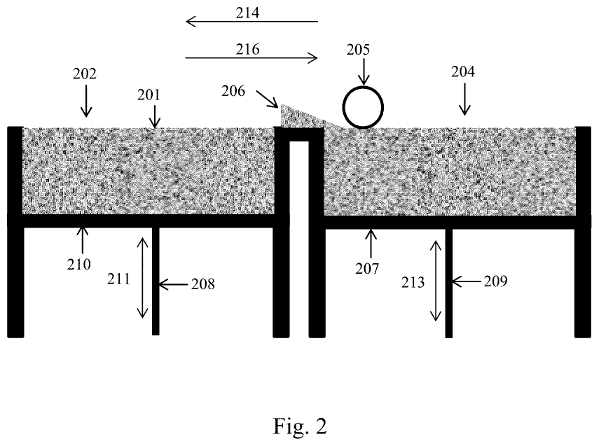

The 3D printer may include a layer forming device (e.g., 113) (also referred to herein as a “layer dispenser”), which is configured to form one or more layers of powder (e.g., as part of the powder bed (e.g., 104). The layer forming device may include a powder dispenser (e.g., 116) and/or a leveler (e.g., 117). The leveler (also referred to herein as “planarizer”) can include at least one blade or roller that contacts the powder bed to provide a leveled (e.g., planar) exposed surface for the powder bed. In some embodiments, the 3D printer includes a container (e.g., a reservoir) for holding a supply of powder. FIG. 2 shows a side view of an example container 204 adjacent build module 202, which includes platform 210. The platform can be (e.g., vertically) translatable 211 by an elevator 208 (comprising an actuator). In some cases, the layer forming device (e.g., 205) translates and pushes a portion (e.g., 206) of the powder from the container to the region above the platform. The layer forming device can include one or more rollers and/or one or more blades. The roller(s) and/or blade(s) may planarize an exposed surface (e.g., 201) of the powder. The translation can be in a first direction (e.g., 214) toward a region above the platform, and in a second direction (e.g., 216) toward the container (e.g., to prepare for forming a subsequent layer). In some embodiments, a second elevator (e.g., 209) of the container is translatable (e.g., 213) so as to translate the supply of powder (e.g., upward). The translating of the layer forming device can be in directions (e.g., substantially) perpendicular to a translation direction (e.g., 211) of the platform and/or a translation direction (e.g., 213) of the support member (e.g., 207) of the container. In some embodiments, the layer forming device is configured to provide a layer of powder having a thickness ranging from about 20 micrometers (□m) to about 500□m.

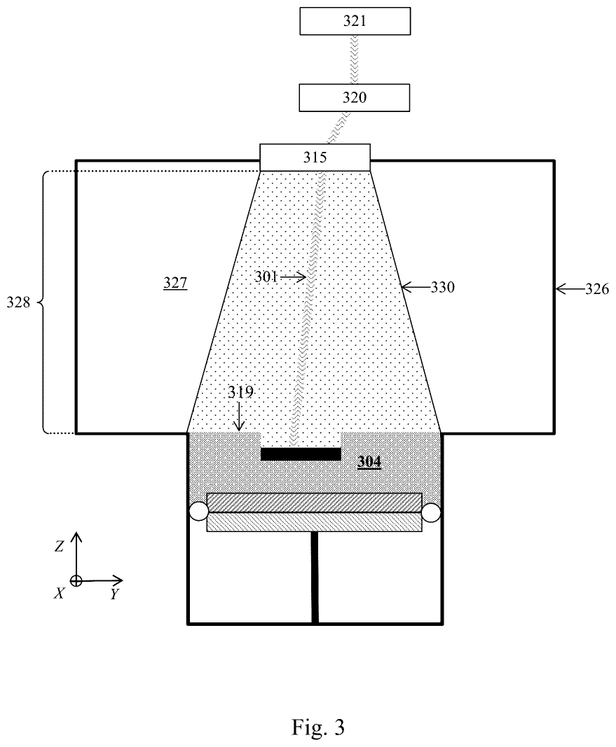

The laser beam(s) may travel through a region of the processing chamber referred to as a processing cone region (also referred the herein as a “processing cone”). FIG. 3 shows a cross section view of an example printer having a laser 321 that is configured to direct a laser beam 301 through a window 315 and an internal volume 327 of a processing chamber 326, towards an exposed surface 319 of a powder bed 304. One or more optical elements 320, which may include one or more scanners, can be configured to move the laser beam (e.g., by deflection) in accordance with a predetermined path along the target surface (e.g., surface of a powder bed 304). Movement of the laser beam(s) during a printing operation can causes the laser beam(s) to potentially occupy a volume within the processing chamber between the area or point of entry of the laser beam into the processing chamber (e.g., the interior surface of the window 315) and the area of the surface of the powder bed—referred to as the processing cone region 330. The processing cone may correspond to a region between the powder bed and the window(s). The processing cone may include regions within the internal volume that the laser beam may potentially occupy when impinging upon the powder bed and/or transformed (e.g., melted or hardened) material. The processing cone may include regions within the internal volume that the laser beam may occupy during scanning of the powder bed and/or transformed (e.g., melted or hardened) material. If multiple laser beams are used during a printing operation, the processing cone region may include the volume between the areas or points of entry of the multiple laser beams (e.g., interior surfaces of the windows) and the area of the surface of the powder bed. The height 328 of processing cone region can span a distance between the interior surface of the window 315 and the surface 319 of the powder bed. In some embodiments, the processing cone region has a height 328 ranging between about 10 centimeters (cm) and about 100 cm. In some cases, the processing cone region includes at least a portion of the powder bed. The shape of the processing cone region may vary. In some embodiments, the shape of the processing cone region is a cone, a pyramid (e.g., square pyramid), a frustum (cut-off pyramid), a cylinder, a tetrahedron, a cube or a prism (e.g., triangular prism, hexagonal prism or pentagonal prism). In some embodiments, the processing cone region has a symmetric shape (e.g., substantially symmetric about a central axis). In some embodiments, the processing cone region has a non-symmetric shape. The processing cone may have a shape depending on the motion range of the laser(s), that may depend on the shape of the platform. In addition, the laser beam 301 itself can define a volume within the processing chamber (and within the processing cone)—referred to herein as the laser beam volume. A laser beam volume can be defined as the volume encompassed by the laser beam along height 328 between the interior surface of the window 315 and the surface 319 of the powder bed.

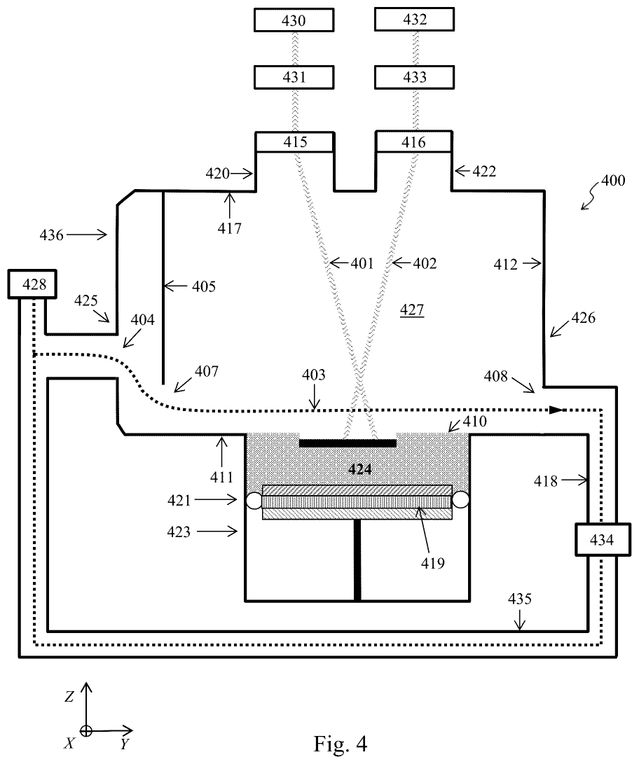

In some cases, the printer includes more than one laser. For example, the printer can have two, three, four, five, or more lasers. FIG. 4 shows a section view of a portion of an example printer having two lasers 430 and 432, optical elements 431 and 433 and windows 415 and 416 for directing laser beams 401 and 402 respectively toward the powder bed 424. In some embodiments, the window(s) (e.g., 415 or 416) is/are within recessed portions (e.g., 420 or 422) of the enclosure (e.g., processing chamber). At one time, at least two of the lasers can be used simultaneously or sequentially (e.g., one at a time). In some applications, multiple laser beams (e.g., 2, 3, 4, or 5) are used in parallel. In some cases, at least two laser beams are scanned at different rates, and/or along different paths. For example, the movement of a first laser beam may be faster than the movement of a second laser beam. In some cases, at least two laser beams are scanned at (e.g., substantially) the same rates, and/or along (e.g., substantially) the same paths.

In some embodiments, the printing systems described herein are configured to control an amount of water vapor within the atmosphere of the enclosure (e.g., processing chamber) during printing of the 3D object(s). The concentration of water vapor within an atmosphere can be associated with a level of oxygen within a 3D object. When exposed to the elevated temperatures of the printing process, oxygen from the water vapor may become incorporated within the 3D object. In some applications, high levels of water vapor can result in undesirable outcomes, such as defects within the 3D object. The tolerance as to the level of water vapor will vary depending, in part, on the material of the 3D object. In some applications, an atmospheric water vapor concentration within a prescribed range is not (e.g., substantially) associated with causing defects. In some applications, the prescribed range of water vapor concentration may be beneficial to the material properties of the 3D object. Some materials, such as some metal alloys, have a prescribed level of oxygen in order to attain certain mechanical and/or thermal properties. The metal alloy can be any type of alloy (e.g., comprising iron, titanium, aluminum, chromium, nickel, copper, zirconium and/or tin). Mechanical properties can include tensile strength, yield strength, shear strength, tensile strength, fatigue strength, elastic modulus, shear modulus, Poisson's ratio, percent elongation at break and/or workability. Thermal properties can include thermal conductivity, thermal expansion and/or specific heat capacity. In some cases, incorporated oxygen may stabilize certain crystalline structure phases within the alloy, which are associated with certain desired mechanical and/or thermal properties. In some cases, the alloys are copper alloys, such as zirconium copper alloys (e.g., zirconium copper aluminum nickel (ZrCuAlNi) or zirconium copper boron (ZrCuB) alloys). In some cases, the alloys are titanium alloys, such as titanium aluminum (TiAl) alloys. The titanium alloys can include any of a number of crystallographic forms (e.g., alpha titanium, beta titanium, and alpha-beta titanium). Examples of titanium alloys include titanium aluminum vanadium alloys (e.g., Ti—6Al—4V), titanium aluminum vanadium tin alloys (e.g., Ti—6Al—6V—2Sn), titanium aluminum tin lithium alloys (e.g., Ti—5Al—2Sn—3Li), and titanium aluminum molybdenum vanadium alloys (e.g., Ti—8Al—1Mo—1V). In some cases, the alloys are classified by grades (e.g., according to ASTM International standard) based, in part, to their material qualities and oxygen content. For example, some titanium alloys, such as a Ti—6Al—4V alloys (also referred to as Ti64 or TC4), are classified by grades. Grade 5 Ti—6Al—4V alloys are specified to have 0.2% of oxygen or less by weight according to ASTM International standards. Grade 23 and grade 29 Ti—6Al—4V alloys are specified to have 0.13% of oxygen or less by weight according to ASTM International standards. It is believed that oxygen stabilizes the hexagonal close packed (known as alpha (a)) crystalline structure of some grades of Ti—6Al—4V alloys and is associated with providing a higher strength alloy.

The water vapor concentration within the internal volume can be modified using any of a number of techniques. In some embodiments, a desiccant (e.g., molecular sieves, silica, alumina, asbestos) is introduced into the internal volume of the processing chamber to adsorb and remove at least some of the water from the atmosphere. For example, a container containing a desiccant can be positioned within the processing chamber. In some embodiments, a reducing agent gas (e.g., hydrogen, methane or carbon monoxide) is introduced into the internal volume of the processing chamber. In some embodiments, an (e.g., mildly) hygroscopic material (e.g., barium oxide, calcium chloride, magnesium sulfate) is introduced into the internal volume of the processing chamber. In some embodiments, a dehumidifying device is used to remove humidity from the atmosphere. The dehumidifying device may cool the gas (e.g., using a refrigerated coil) that cause at least some of the water to condense out of the gas prior to entering the internal volume of the chamber. In some cases, the dehumidifying device is coupled to a conduit (e.g., 418) that supplies the gas into the processing chamber. In some embodiments, the powder is pre-treated to remove a least some of the adsorbed moisture prior to entering into the processing chamber. In some cases, this is accomplished using a heating element (e.g., 419). The heating element may be configured to heat the powder bed before, during and/or after a printing operation. The heating element may be actively heated (e.g., coupled to an electrical heater or using a recirculating liquid (e.g., water or oil)). The heating element may be within the internal volume of the build module (e.g., 423). In some cases, the heating element is coupled with, or is part of, the platform (e.g., 421). In some cases, the heating element includes a plate. The heating element may be configured to heat the powder to a temperature sufficient to remove at least some water from powder by vaporization. The heating element may heat the powder before, during or after printing. In some embodiments, the heating element is configured to heat the powder to a temperature at least about 100 degrees Celsius (° C.), 150° C., 200° C., 250° C., 300° C., 350° C., 400° C., 450° C., 500° C. or 1000° C.). The heating element may be configured to heat the powder to a temperature between any of the aforementioned values (e.g., from about 100° C. to about 1000° C., from about 100° C. to about 400° C., from about 400° C. to about 1000° C., or from about 100° C. to about 500° C.).

According to some embodiments, the printing apparatus includes a gas flow system, which may be used to at least partially control the water vapor concentrations within certain portions of the enclosure. The gas flow system may maintain a water vapor concentration within a prescribed. FIG. 4 shows a section view of a portion of an enclosure 400 for a 3D printer that includes a gas flow system. The enclosure can include a processing chamber (e.g., 436) that defines an internal volume (e.g., 427) configured to enclose at least an exposed surface (e.g., 410) of a powder bed (e.g., 424). The gas flow system can be coupled to, or be part of, the processing chamber. The gas flow system can include an inlet region (e.g., 425) and an outlet region (e.g., 426), which can facilitate a flow of gas (e.g., 403) through at least a portion of the internal volume of the processing chamber. According to some embodiments, the inlet and outlet regions are positioned so that at least a portion of the flow of gas (e.g., 403) is over at least part of the exposed surface of the powder bed. In some embodiments, the flow of gas is directed toward the exposed surface of the powder bed.

The inlet and outlet regions can be coupled to, or be part of, any wall of the processing chamber. In some cases, the inlet region is along one side wall (e.g., 412 or 405) of the processing chamber, and the outlet region is along an opposing side wall (e.g., 412 or 405) of the processing chamber. In some cases, the inlet region is along the ceiling (e.g., 417) of the processing chamber, and the outlet region is along one or more side walls (e.g., 412 or 405) and/or the floor (e.g., 411) of the processing chamber. In some embodiments, at least a portion of the flow of gas is (e.g., substantially) parallel to the surface of powder bed. A (e.g., substantially) parallel flow of gas can be in a direction that is about 0 degrees)(°, 1°, 5°, 10°, 20°, 30° or 40° relative to the exposed surface of the powder bed and/or a support surface of the platform (e.g., 421). In some embodiments, at least a portion of the flow of gas is a laminar flow of gas (e.g., at least above the exposed surface of powder bed). In some embodiments, the flow of gas is directed toward the powder bed, then travels along the exposed surface of the powder bed before exiting the outlet region.

The inlet region can include one or more inlet ports (e.g., 404) that is/are operationally coupled with a gas source (e.g., 428). In some embodiments, the inlet ports is/are operationally coupled with multiple gas sources, which can provide the same or different types of gas. In some embodiments, the gas source(s) may provide a gas that is (e.g., substantially) free of water. Substantially free of water may be no more than about 5 parts-per million (ppm), 4 ppm, 3 ppm, 2 ppm, 1 ppm, 0.5 ppm, 0.2 ppm or 0.1 ppm by volume. Substantially free of water may be between any of the aforementioned values (e.g., from about 0.1 ppm to about 5 ppm, from about 0.1 ppm to about 3 ppm, from about 3 ppm to about 5 ppm, or from about 0.2 ppm to about 3 ppm). In some embodiments, the gas source(s) may provide an inert gas, such as nitrogen and/or argon. The inert gas may be (e.g., substantially) non-reactive (e.g., non-chemically reactive) with the powder during a printing operation. The inert gas may be (e.g., substantially) free of water. The inlet region (e.g., 425) may include structures, such as internal walls, baffles and/or channels that modify fluid dynamics of the flow of gas. In some embodiments, the inlet region includes a wall (e.g., 405) that separates the inlet region from the internal volume (e.g., 427) of the processing chamber. The gas can enter the inlet region at the one or more inlet ports and exit the inlet region via one or more inlet openings (e.g., 407). In some embodiments, the one or more inlet ports correspond to the one or more inlet openings (e.g., in case wall 405 does not exist). The inlet region can include any suitable number of inlet ports and/or inlet openings (e.g., at least 1, 2, 3, 4, 5, 6, 7, 8, 9, or 10).

The outlet region (e.g., 426) can include one or more outlet openings (e.g., 408) for the flow of gas to exit the enclosure (e.g., processing chamber). The outlet region can include any suitable number of outlet openings (e.g., at least 1, 2, 3, 4, 5, 6, 7, 8, 9, or 10). In some cases, the gas may flow through the processing chamber (at least in part) toward the outlet opening(s) due to a pressure difference between the inlet and outlet regions. In some cases, the one or more outlet openings are (e.g., fluidly) coupled one or more pumps (e.g., 419) that assist movement of the flow of gas through the processing chamber. The pump(s) may include a positive displacement pump (e.g., rotary) and/or a vacuum pump (e.g., Venturi). In some embodiments, the one or more outlet openings are operationally (e.g., fluidly) coupled with a gas recycling system (e.g., 435) that recycles the gas back through the inlet region (e.g., 425). The outlet opening(s) may be coupled to the recycling system via a conduit (e.g., 418), which can facilitate passing of the flow of gas through the internal volume of the enclosure. The conduit may include one or more tubes, pipes, ducts, channels, cables, or tunnels. The gas recycling system can include one or more filter(s) (e.g., 434), which filter out particles (e.g., powder and/or debris) from the gas. In some embodiments, the filter(s) include a paper filter, a High efficiency particulate air (HEPA) filter and/or membrane filter.

In some embodiments, the inlet port(s) (e.g., 404), inlet opening(s) (e.g., 407) and/or outlet opening(s) (e.g., 408) correspond to openings within, or comprise: a perforated plate, a screen, a mesh and/or a gas permeable material. The gas permeable material may include a block or a slab of material. The gas permeable material may include a material having (e.g., random) passages, voids (e.g., bubbles), and/or holes. The gas permeable material may include elemental metal, metal alloy, ceramic, an allotrope of elemental metal, a polymer, and/or a resin. In some embodiments, the inlet port(s), inlet opening(s), and/or outlet opening(s) are operationally coupled to one or more valves and/or nozzles. The valve(s) and/or nozzle(s) can control an amount (e.g., on or off) and/or a velocity of the flow of gas into the processing. The valve(s) and/or nozzle(s) may be controlled manually or automatically (e.g., using one or more controllers). The nozzle(s) may include jet (e.g., gas jet) nozzle, high velocity nozzle, propelling nozzle, magnetic nozzle, spray nozzle, vacuum nozzle, Venturi nozzle, or shaping nozzle (e.g., a die). The nozzle can be a convergent or a divergent nozzle. The spray nozzle may comprise an atomizer nozzle, an air-aspirating nozzle, or a swirl nozzle.

In some embodiments, the pressure of the atmosphere within the internal volume of the enclosure (e.g., processing chamber) is about one (1) atmosphere. In some embodiments, the pressure within the internal volume of the enclosure (e.g., processing chamber) is (e.g., substantially) equal to that of the atmosphere external to the processing chamber and/or the printer enclosure (e.g., ambient pressure). In some embodiments, the pressure within the internal volume of the enclosure (e.g., processing chamber) is about 1 kilopascal (kPa), 2 kPa, 3 kPa, 4 kPa, 5 kPa, 6 kPa, 7 kPa, 8 kPa, 9 kPa, 10 kPa, 12 kPa, 14 kPa, 16 kPa, 18 kPa, 20 kPa or 50 kPa above or below ambient pressure during printing. The pressure within the internal volume of the enclosure (e.g., processing chamber) can be between any of the aforementioned values (e.g., from about 50 kPa below to about 50 kPa above ambient pressure, from about ambient pressure to about 50 kPa above ambient pressure, from about 50 kPa below ambient pressure to about ambient pressure, or from about 2 kPa below ambient pressure to about 2 kPa above ambient pressure) during printing.

The temperature of the atmosphere within the internal volume of the enclosure can vary depending, in part, on an ambient temperature, the time during a printing operation (e.g., beginning or end of printing), the temperature and speed of the flow of gas, the laser beam power, and/or the number of lasers and/or laser beams used during printing. The ambient temperature can correspond to a temperature external to the processing temperature and/or the printer (e.g., temperature of a factory (e.g., room temperature)). The temperature of the atmosphere may vary among different regions within the internal volume of the enclosure. In some embodiments, a (e.g., average) temperature of the atmosphere of the internal volume of the enclosure (e.g., processing chamber) is at least about 5 degrees Celsius (° C.), 10° C., 20° C., 30° C., 40° C., 50° C., 60° C., 70° C., 80° C., 90° C. or 100° C. during printing. The (e.g., average) temperature of the atmosphere within the internal volume can range between any of the aforementioned values (e.g., from about 5° C. to about 100° C., from about 5° C. to about 50° C., from about 50° C. to about 100° C., or from about 20° C. to about 50° C.) during printing.

Water within the atmosphere of the enclosure (e.g., processing chamber) may originate from any of a number of sources. The water may be from an environment external to the enclosure (e.g., processing chamber). The external environment may be an atmosphere of another chamber with which the enclosure (e.g., processing chamber) is operationally coupled. For example, the external environment may be at atmosphere of an unpacking station, build module, or a docking station where the 3D object(s) may be removed. The external environment may be an ambient atmosphere where the printer is located. In some embodiments, water from the external environment enters the internal volume of the enclosure when the processing chamber (e.g., FIG. 1, 126) and a build module (e.g., FIG. 1, 123) are decoupled from one another (e.g., between builds). In some cases, the decoupling increases the water vapor concentration within the processing chamber. In some cases, the decoupling decreases the water vapor concentration within the processing chamber. In some cases, the water may be from the powder within the powder bed. For instance, water may be adsorb on the surfaces of the particles of powder and/or absorb in particles of powder, which can remain in and/or on the particles when placed within the enclosure (e.g., processing chamber). Moisture within the powder can vaporize and enter the atmosphere within the processing chamber until it reaches an equilibrium moisture content. Heating the powder bed and/or the atmosphere may accelerate vaporization of the moisture. In some cases, the water may be from the internal surfaces of the walls (e.g., FIGS. 4, 405, 412, 417 and/or 411) of the enclosure (e.g., processing chamber). For instance, water may condense onto the internal surfaces of the walls between builds (e.g., when the internal volume (e.g., FIG. 4, 427) is exposed to the external environment). In some cases, the water may be from one or more components of the printer. For example, the layer forming device (e.g., FIG. 1, 113 or FIG. 2, 205) may have surfaces with adsorbed water, which can enter the internal volume of the enclosure during a layer forming operation. In some embodiments, the temperatures associated with the melting process can cause regions of the atmosphere within the internal volume of the enclosure to reach a temperature that is high enough to vaporize water from one or more sources. In some embodiments, the water from the one or more sources can mix and/or become entrained within the flow of gas (e.g., FIG. 4, 403) as water vapor. In some cases, the water vapor is incorporated with a flow of inert gas. In some embodiments, the water is from the gas source(s) (e.g., FIG. 4, 428). For instance, a gas source having a known concentration of water may be used in order to achieve a prescribed level of water vapor within the atmosphere of the enclosure during printing.

The concentration of water vapor within the enclosure can be controlled, in part, by controlling one or more characteristics, such direction and/or velocity, of the flow of gas. In some embodiments, at least a portion of the flow of gas is in a direction that is (e.g., substantially) parallel to the exposed surface of the powder bed. In some cases, at least a portion of the flow of gas is in a (e.g., substantially) horizontal direction. A substantially horizontal flow of gas can be in a direction that is about 60°, 70°, 80°, 85°, 89° or 90° with respect to a gravity vector. In some embodiments, at least a portion of the flow of gas is in a direction that is (e.g., substantially) orthogonal to the exposed surface of the powder bed. In some cases, at least a portion of the flow of gas is in a (e.g., substantially) vertical direction. A substantially vertical flow of gas can be in a direction that is about 0°, 5°, 10°, 15°, 20° or 30° with respect to the gravity vector. In some embodiments, the flow of gas is directed at the exposed surface of the powder bed, and is deflected by the surface of the powder bed.

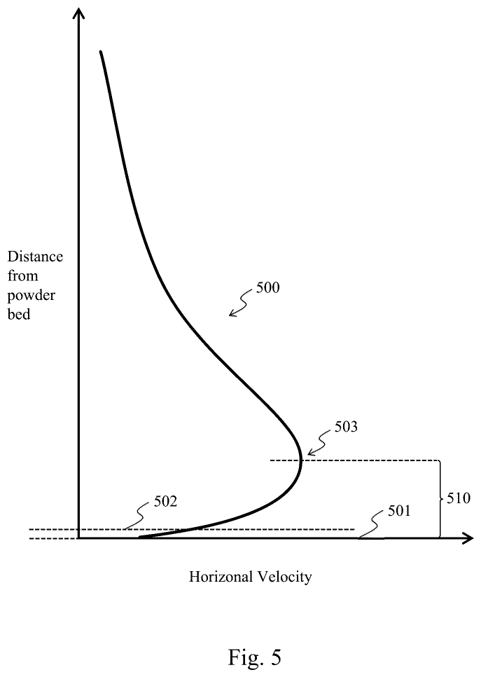

FIG. 5 shows a profile 500 indicating horizontal velocity of a flow of gas within a processing chamber as a function of distance from an exposed surface 501 of the powder bed, in accordance with some embodiments. The gas flow can have a peak horizontal velocity (e.g., 503) at a peak velocity height (e.g., 510) in relation to the exposed surface (e.g., 501) of the powder bed. The peak velocity height (e.g., 510) can vary depending on a number of factors including the positions (e.g., heights) of the inlet and outlet openings and/or the lateral distance along the length of the powder bed and/or the platform, and/or the internal shape of the enclosure. In some embodiments, the peak velocity height (e.g., 510) is at least about 5 millimeters (mm), 6 mm, 7 mm, 8 mm, 9 mm, 10 mm, 12 mm, 15 mm, 20 mm, 25 mm, 30 mm, 40 mm, 50 mm, 60 mm, 70 mm, 80 mm, 90 mm, 100 mm, 120 mm, 150 mm, or 200 mm from the exposed surface of the powder bed and/or platform. The peak velocity height (e.g., 510) can range between any of the afore-mentioned values (e.g., from about 5 mm to about 200 mm, from about 1 mm to about 30 mm, from about 30 mm to about 200 mm, from about 15 mm to about 50 mm, or from about 15 mm and about 100 mm) above the surface of the powder bed and/or platform. The peak velocity height (e.g., 510) can be above a height (e.g., 502) of a boundary layer, which refers to a region immediately above the surface of the powder bed where effects of viscosity may be significant such that horizontal velocity immediately across the powder bed may be relatively low. In some embodiments, the height (e.g., 502) of the boundary layer is at most about 1 mm, 2 mm, 3 mm, 4 mm, 5 mm, 6 mm, 7 mm, 8 mm, 9 mm or 10 mm from the surface of the powder bed.

In some cases, the flow of gas is continuously provided in the enclosure (e.g., processing chamber) during a printing operation. In some cases, the flow of gas is provided in the enclosure (e.g., processing chamber) during only a portion of the printing operation. In some cases, the velocity of the flow of gas remains (e.g., substantially) constant during the printing operation (e.g. at least during melting). In some cases, the velocity of the flow of gas is varied during the printing operation (e.g. during melting). In some cases, the velocity of the flow of gas is continuous during the printing operation (e.g., during a build). In some cases, the velocity of the flow of gas is intermittent during the printing operation. For example, a flow of gas may persist during irradiation of the laser and cease during planarization of the exposed surface of the powder bed. One or more valves of the inlet port(s), inlet opening(s) and/or outlet opening(s) can be used to control the velocity and or amount (e.g., on/off) of the flow of gas. In some cases, the velocity (i.e., volumetric flow rate) of the flow of gas is at least about 0.01 m/s, 0.05 m/s 0.1 m/s, 0.5 m/s, 1 m/s, 2 m/s, 3 m/s, 5 m/s, 10 m/s, 15 m/s, 20 m/s, 30 m/s or 50 m/s. The velocity of the flow of gas can be at most about 0.1 m/s, 0.2 m/s, 0.3 m/s, 0.5 m/s, 0.7 m/s, 0.8 m/s, 1 m/s, 2 m/s, 3 m/s, 5 m/s, 10 m/s, 15 m/s, 20 m/s, 30 m/s, or 50 m/s. The velocity of the flow of gas can be between any of the afore-mentioned values (e.g., from about 0.01 m/s to about 50 m/s, from about 0.01 m/s to about 2 m/s, from about 2 m/s to about 50 m/s, or from about 0.2 m/s to about 2 m/s). The velocity can be measured using any suitable technique(s) and device(s). For example, one or more flow meters (e.g., anemometer, sonar flow meter, air flow meter, particle image velocimetry device, or laser Doppler velocimetry device) may be used to measure the gas flow velocity across one or more prescribed distances above the surface of the powder bed.

According to some embodiments, the flow of gas causes a turbulent movement of gas within at least a portion of the internal volume of the enclosure (e.g., processing chamber). The turbulent movement of gas may facilitate mixing of gas (e.g., including water vapor) within the internal volume. In some embodiments, the turbulent movement facilitates the distribution of heat within the internal volume. For example, the temperature of the atmosphere near the exposed surface (e.g., FIG. 4, 410) of the powder bed (e.g., FIG. 4, 424) may be higher than the temperature of the atmosphere near the ceiling (e.g., FIG. 3, 317) due to the melting occurring at the powder bed. The movement of gas (e.g., FIG. 4, 403) may facilitate distribution of the heated gas generated near the powder bed toward other regions of the enclosure (e.g., toward the ceiling (e.g., FIG. 4, 417). The turbulent movement of gas may include a cyclic movement, a backflow, a vortex, or a chaotic movement of gas. The turbulent movement of gas may be a (e.g., substantially) non-laminar movement of gas. In some embodiments, the turbulent movement of gas occurs within certain portions of the enclosure compared to other portions of the enclosure. For example, in some embodiments, most (e.g., greater than 50%) of the turbulent movement of gas occurs above at least about 5 cm, 10 cm, 15 cm, 20 cm, 25 cm, 30 cm, 40 cm, 50 cm, 60 cm, 70 cm, 80 cm, 90 cm or 100 cm from the exposed surface of the powder bed and/or platform.

The flow of gas may (alternatively or additionally) be used to modify concentrations of species other than water within the atmosphere. In some embodiments, the flow of gas is used to modify the concentration of solid material within the atmosphere of the enclosure. For example, debris (e.g., powder particles, partially melted powder particles and/or soot) may become gas-borne at the exposed surface of the powder bed. The flow of gas may be used to modify (e.g., decrease or increase) a concentration of debris within the enclosure. The flow of gas may be used to entrain some of the debris away from the exposed surface of the powder bed and out of the enclosure via the outlet region. The flow of gas may be used to modify a distribution of debris within the enclosure.

The printing systems described herein can be used to form high quality 3D objects in accordance with desired characteristics. For example, in some applications, it is desirable for the objects to have a low porosity and/or low surface roughness. In some embodiments, the printer is configured to print a 3D object having a porosity of about 1% or less by volume (e.g., as measured within any volume of the 3D object). The porosity may be measured within the interior and/or a surface of 3D object. In some embodiments, the printer is configured to print a 3D object having a surface roughness of about 50 micrometers or less (e.g., as measured on any exterior surface of the 3D object). In some applications, the printer is configured to print in an atmosphere having the prescribed level of water vapor while resulting in a 3D object having low porosity (e.g., about 1% or less by volume) and/or low surface roughness (e.g., about 50 micrometers or less).

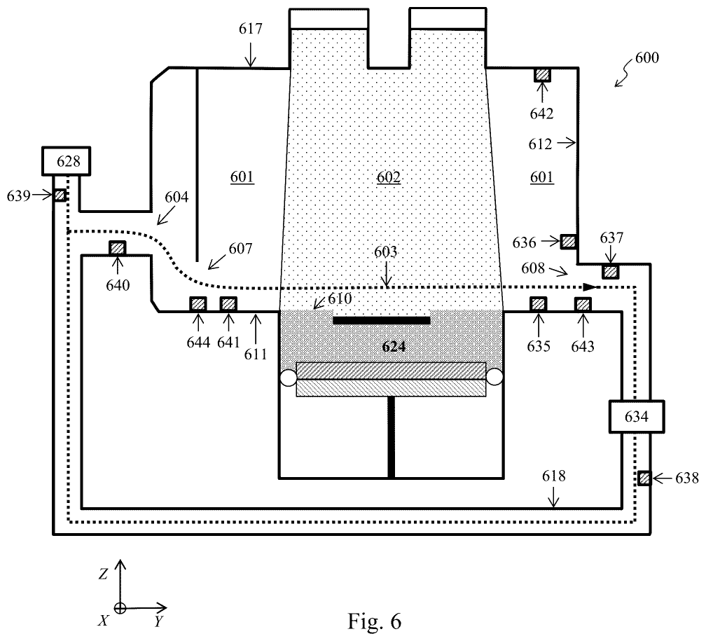

In some embodiments, the printer includes one or more sensors to detect characteristics of the atmosphere and/or the flow of gas. The sensor(s) may be part of the 3D printer, or may be a component separate from the 3D printer. The sensor(s) may be used to determine a (e.g., chemical) composition of the atmosphere. The sensor(s) may be used to facilitate measurement of water vapor concentration. The sensor(s) may be used to facilitate measurement of particles (e.g., soot) (e.g., as part of a particle counter). The sensor(s) may be used to facilitate measurement of gas flow velocity in certain portions of the internal volume. The sensor(s) may include temperature, pressure, capacitive, resistive and/or thermal sensors. In some embodiments, the sensor(s) include, or are operationally coupled to, a hygrometer. The hygrometer may be of any suitable type (e.g., capacitive, resistive, thermal or gravimetric). The sensor(s) may be used to determine water vapor concentration at localized regions of the enclosure. FIG. 6 shows a section view of a portion of an enclosure 600 for a 3D printer that includes sensor(s). The sensor(s) may be exposed to the flow of gas (e.g., 603). Exposed to the flow of gas can be within the internal volume of the chamber (e.g., including turbulent portions of the flow of gas) or outside of the internal volume of the processing chamber (e.g., within a conduit (e.g., 618)). The conduit can include a portion coupled to the inlet opening(s) and a portion coupled to the outlet opening(s). The sensor(s) (e.g., 643) may be located within (e.g., at) the outlet opening(s) (e.g., 608). The sensor(s) (e.g., 635, 636, 641, or 642) may be located within processing chamber. The sensor(s) may be coupled to one or more walls of the processing chamber, such as a side wall (e.g., 612), floor (e.g., 611) and/or ceiling (e.g., 617). In some cases, the sensor(s) is/are located in a region (e.g., 601) outside of a region of the internal volume between the external surface of the powder bed (or support surface of the platform) and an internal surface of the window(s). In some cases, the sensor(s) is/are located in a region (e.g., 601) of the internal volume that is not within the processing cone region (e.g., 602) of the processing chamber (e.g., outside of the processing cone). The processing cone region may have variable water vapor concentrations. In some cases, the sensor(s) is/are located in a region (e.g., 601) of the internal volume that is adjacent to the processing cone region. In some embodiments, the sensor(s) is/are not located above the powder bed (e.g., 624).

The sensor(s) (e.g., 637, 638, 639, or 640) may be within regions of the printer outside of the processing chamber, such as in a conduit (e.g., 618) that directs the flow of gas in and/or out of the processing chamber. In some cases, the sensor(s) is/are located downstream from the outlet opening(s) (e.g., 608). Downstream from the outlet opening(s) can correspond to a location past the outlet opening(s) in the direction of the flow of gas (e.g., 603). In some embodiments, the sensor(s) (e.g., 637) is/are located downstream of the outlet opening(s) and/or upstream from one or more filters (e.g., 634) (e.g., as part of a gas recycling system). Upstream from one or more filters can correspond to a location prior to the filter(s) in a direction opposite that of the flow of gas (e.g., 603). In some cases, the sensor(s) is/are located within at a predetermined distance from the outlet opening(s). The predetermined distance can be at most about 1 centimeter (cm), 5 cm, 6 cm, 7 cm, 8 cm, 9 cm, 10 cm, 15 cm, 20 cm. In some embodiments, the sensor(s) (e.g., 638) is/are located within downstream from the filter(s) (e.g., 634). The sensor(s) (e.g., 639) may be positioned near the gas source(s)(e.g., 628)— in some cases within the predetermined distance from the gas source(s). The sensor(s) (e.g., 643) may be positioned within the one or more inlet openings (e.g., 607). The sensor(s) (e.g., 640) may be positioned within the conduit (e.g., 618) near the one or more inlet openings (e.g., 607)— in some cases within the predetermined distance from the one or more inlet openings. The sensor(s) (e.g., 641) may be positioned within the processing chamber near the one or more inlet openings (e.g., 607)— in some cases within the predetermined distance from the one or more inlet openings. The sensed information may vary depending, in part, on the location of the sensor(s). For example, when the gas source provides a gas that is (e.g., substantially) free of water, the water vapor concentration at or near the outlet opening(s) (e.g., using sensors 635, 636, or 637) may be greater than the water vapor concentration at or near the inlet port(s) or inlet opening(s) (e.g., using sensors 640 or 641). This can be due to the flow of gas (e.g., 603) entraining moisture from the internal volume of the processing chamber, such as from the powder bed (e.g., 624).

In some embodiments, the water vapor concentration within the enclosure is quantified using relative humidity. Relative humidity is the ratio of the partial pressure of water vapor to the equilibrium vapor pressure of water at a given temperature, and which is typically expressed as a percentage. Given a certain pressure, the relative humidity within the enclosure (e.g., processing chamber) depends on the temperature of the atmosphere within the enclosure. For example, the relative humidity increases as the temperature decreases. In some cases, the atmosphere within different regions of the enclosure (e.g., processing chamber) will have different temperatures, and therefore may have differing relative humidity values. For example, the temperature of the atmosphere near the exposed surface (e.g., 610) of the powder bed (e.g., 624) may be higher than the temperature of the atmosphere near the ceiling (e.g., 617) (e.g., due to the melting occurring at the powder bed). Thus, during printing, the relative humidity of a region of the atmosphere near the powder bed (e.g., 624) may be less than that of a region of the atmosphere near the ceiling (e.g., 617). In some cases, the water vapor concentration can be quantified using dew point temperature, which refers to the temperature at which a gas is be cooled to become saturated with water vapor. Cooling the gas beyond its dew point temperature will cause the water vapor to condense and form liquid water. In some cases, the water vapor concentration can be quantified using parts-per million (ppm) notation. Water vapor concentrations expressed in dew point temperature and parts-per million values can be expressed independent of temperature.

The water vapor concentration may be measured at any location of the printer. In some embodiments, the water vapor concentration is measured at a location corresponding to sensor locations of FIG. 6. In some cases, the water vapor concentration is measured at or near the one or more outlet openings since the gas within the atmosphere can converge at the one or more outlet openings. In some cases, the flow of gas may entrain water vapor while traveling through the processing chamber such that the flow of gas reaches a relatively high (e.g., maximum) water concentration at or near the one or more outlet openings. In some cases, water vapor concentration is measured at a location within the one or more outlet openings, within the chamber and outside of the processing cone region, or within the conduit and downstream from the one or more outlet openings. In some cases, water vapor concentration is measured in the internal volume of the processing chamber, and outside of a volume having (1) a first face that is the exposes surface or the powder bed or the platform, (2) a second face identical to the first face in shape and size and parallel thereto, and (3) a third face connecting the first and the second face, which third face is perpendicular to the first face and to the second face (e.g., the volume can have a cylinder shape or polyhedron shape). In some cases, water vapor concentration is measured within the prescribed distance from the outlet opening(s). In some embodiments, the relative humidity of the atmosphere within the prescribed distance from the outlet opening(s) is at least about 1 percent (%), 2%, 3%, 4%, 5%, 10%, 15%, 20%, 25%, 30% or 50% during printing. The relative humidity may range between any of the aforementioned values (e.g., from about 1% to about 50%, from about 1% to about 20%, from about 20% to about 50%, from about 1% to about 20%, or from about 1% to about 25%) during printing. The relative humidity can be measured when the atmosphere (e.g., at or within the predetermined distance from the outlet opening(s)) has a temperature ranging between about 20 degrees Celsius (° C.) to about 50° C. In some embodiments, the dew point temperature is at least about minus (−)40 degrees Celsius (° C.), −35° C., −30° C., −25° C., −20° C., −15° C., −10° C., −5° C., −4° C., −3° C., −2° C., −1° C., 0° C., 1° C., 2° C., 3° C., 4° C., 5° C., or 10° C. during printing. The dew point temperature of the atmosphere within the prescribed distance from the outlet opening(s) may range between any of the aforementioned values (e.g., from about −40° C. to about 10° C., from about −40° C. to about −5° C., from about −5° C. to about 10° C., from about −40° C. to about 0° C., from about −40° C. to about 5° C., or from about −40° C. to about −20° C.) during printing. In some embodiments, water vapor concentration in parts-per million (ppm) of the atmosphere within the prescribed distance from the outlet opening(s) is at least about 75 ppm, 100 ppm, 200 ppm, 300 ppm, 400 ppm, 500 ppm, 600 ppm, 700 ppm, 800 ppm, 900 ppm, 1000 ppm, 5000 ppm, 10000 ppm, or 15000 ppm during printing. The water vapor concentration in ppm may range between any of the aforementioned values (e.g., from about 75 ppm to about 15000 ppm, from about 75 ppm to about 5000 ppm, from about 5000 ppm to about 15000 ppm, from about 1000 ppm to about 15000 ppm, from about 3000 ppm to about 15000 ppm, or from about 600 ppm to about 15000 ppm) during printing.

The 3D printers described herein can include one or more controllers that are operatively coupled with one or more components of the 3D printer, which one or more controllers control(s) operation of the one or more components. Control may comprise regulate, manipulate, restrict, direct, monitor, adjust, attenuate, maintain, modulate, or manage. In some cases, the controller(s) control the motion or activation of one or more components. The one or more controllers can be part of a control system. The control system may be able to receive signals relating to the one or more components to be used (e.g., in feedback, feed-forward, open loop, and/or closed loop control schemes). In some embodiments, the control is in real time (e.g., during printing). The control can be before, during and/or after a printing operation. The controller(s) may direct the engagement and/or disengagement of the build module with the processing chamber. The controller(s) may direct transiting the build module to a further processing station (e.g., a polishing, heat treatment, or an unpacking station). The controller(s) may direct movement (e.g., vertical translation) of the platform. The controller(s) can direct the one or more lasers to generate the one or more laser beams (e.g., laser beams). The controller(s) may regulate the one or more aspects (e.g., characteristics) of the laser beams (e.g., wavelength range, laser power, power density, speed, dwell time, intermission time, focus (or defocus), cross-section, pulsing frequency, and/or irradiating as a continuous beam). The controllers can control the laser source (e.g., by controlling its power). The controller(s) may control the position(s) of the one or more laser beams with respect to the platform (e.g., control the trajectory of the energy beam). For example, the controller(s) may control the optical element(s) (e.g., lenses, mirrors, beam-splitters, and/or scanners). The controller(s) may control the operation of one or more valves (e.g., gas inlet and/or outlet valves) of the printer (e.g., for controlling the flow of gas), such as by directing the valve(s) to open or close based on predetermined conditions. The valves may comprise pinch valves. The controller(s) may direct the gas flow system to provide the flow of gas within the enclosure. The controller(s) may control the velocity of the flow of gas within the enclosure (e.g., via the valve(s) or nozzle(s)). The controller(s) may control the operation of one or more sensors of the printer (e.g., for sensing a pressure within the processing chamber), such as by directing the sensors to turn on or off based on predetermined conditions. The sensor may be position sensors to determine positions of one or more of the components (e.g., vertical position of the platform). The controller(s) may control the operation of the layer forming device (e.g., any of its components), such as by directing movement (e.g., translation) of the layer forming device. The controller(s) may control the operation of the one or more pumps, such as by directing the pump(s) to turn on or off based on predetermined conditions. The controller(s) may control locking and/or unlocking of doors and/or windows of the enclosure (e.g., processing chamber). The controller(s) may control aspects of software of the printer (e.g., printing directions). The controller may direct operations based on a control scheme (e.g., feedback and/or feedforward control). The control may direct operations based open loop control and/or closed loop control scheme.

The 3D printer can include any suitable number of controllers, and can be used to control any number of suitable (e.g., different) operations. For example, in some embodiments, one or more controllers is used to control one or more components and another one or more controllers is used to control another one or more components. In some embodiments, a number of controllers are used to control one component. In some embodiments, a controller (e.g., a single controller) used to control a number of components. For example, in some embodiments, one or more controllers is used to control the laser(s), and another one or more controllers is used to control aspects of the flow of gas (e.g., velocity).

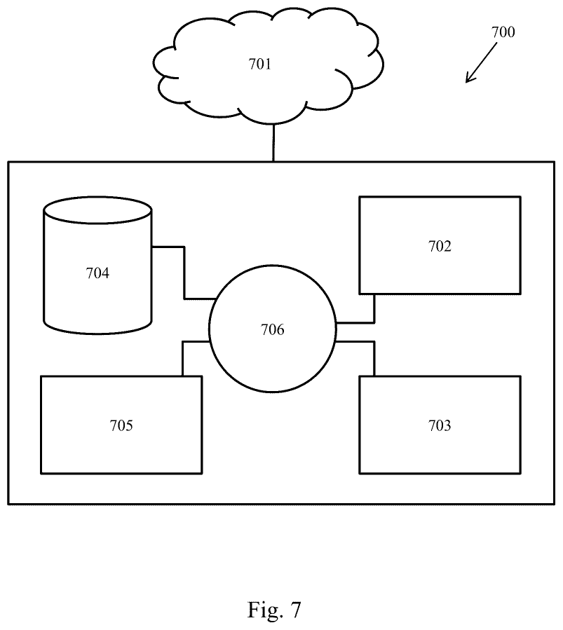

The printers described herein can include, or be in communication with, a computer system that may be operatively coupled to the one or more controllers. FIG. 7 schematically illustrates an example computer system 700 in accordance with some embodiments. The computer system can include a processing unit (e.g., FIG. 706) (also referred to herein as a “processor,” “computer” or “computer processor”), a memory (e.g., 702) (e.g., random-access memory, read-only memory, and/or flash memory), an electronic storage unit (e.g., 704) (e.g., hard disk), communication interface (e.g., 703) (e.g., network adapter) for communicating with one or more other systems, and peripheral devices (e.g., FIG. 705), such as cache, other memory, data storage and/or electronic display adapters. The memory storage unit interface, and peripheral devices can be in communication with the processing unit through a communication bus, such as a motherboard. The storage unit can be a data storage unit (or data repository) for storing data. The computer system can be operatively coupled to a computer network (“network”) (e.g., 701) with the aid of the communication interface. Instructions may be stored in the memory and can be directed to the processing unit, which can subsequently program or otherwise configure the processing unit to implement methods described herein. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet. The computer system can communicate with one or more remote computer systems through a network. For instance, the computer system can communicate with a remote computer system of a user (e.g., operator). Examples of remote computer systems include personal computers, tablet computers, telephones, smart phones, or personal digital assistants. Methods as described herein can be implemented by way of machine (e.g., computer processor) executable code stored on an electronic storage location of the computer system, such as, for example, on the memory or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on the memory.

The printers described herein can include one or more power supplies to supply power to any of the components. The power can be supplied by a grid, generator, local, or any combination thereof. The power supply can be from renewable or non-renewable sources. The renewable sources may comprise solar, wind, hydroelectric, or biofuel. The power supply can comprise rechargeable batteries.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. An apparatus for printing a three-dimensional object, the apparatus comprising:
a platform configured to support a powder bed comprising powder;
a laser configured to generate a laser beam that melts at least a portion of the powder bed to a molten material to print at least a portion of the three-dimensional object;
a layer forming device configured to form a planar layer of the powder as that is at least a portion of the powder bed, the layer forming device being configured to translate in a first direction over an exposed surface of the powder bed to planarize the exposed surface of the powder bed;
an elevator operationally coupled with the platform, the elevator comprising an actuator configured to translate the platform in a second direction perpendicular to the first direction;
a processing chamber having at least one wall that at least partially encloses an internal volume, the processing chamber being configured to enclose at least the exposed surface of the powder bed within an atmosphere of the internal volume during the printing, the at least one wall of the processing chamber comprising a window configured to permit at least a portion of the laser beam to pass therethrough into the internal volume;
a galvanometer scanner configured to translate the laser beam across the exposed surface of the powder bed in accordance with at least one path, the galvanometer scanner being configured to move the laser beam in a processing cone region of the internal volume of the processing chamber;
a gas flow system comprising one or more inlet openings and, or more outlet openings, and at least one gas source, the gas flow system being configured to provide a flow of gas from the at least one gas source through the one or more inlet openings to the internal volume and to the one or more outlet openings, the one or more outlet openings being coupled with a conduit that directs the flow of the gas out of the internal volume via the one or more outlet openings; and
one or more controllers configured to couple with one or more power supplies, the one or more controllers being operationally coupled with the elevator, the layer forming device, the galvanometer scanner, and the gas flow system, the one or more controllers being configured to direct (a) the elevator to translate the platform in the second direction, (b) the layer forming device to translate in the first direction, (c) the galvanometer scanner to direct the laser beam to impinge upon the exposed surface of the powder bed in accordance with the at least one path, and (d) the gas flow system to provide the flow of the gas from the at least one gas source to the internal volume, the flow of the gas comprising water vapor at a concentration that yields a dew point temperature of at least about negative forty (−40) degrees Celsius (° C.) at a location exposed to the flow of the gas, the location being (i) in the one or more outlet openings, (ii) in the internal volume of the processing chamber, or (iii) in the conduit and downstream from the one or more outlet openings.

2. The apparatus of claim 1, wherein the one or more inlet openings are operationally coupled with the at least one gas source that comprises a non-reactive gas source, the non-reactive gas source being configured to provide at least one non-reactive gas as part of the flow of the gas, the non-reactive being non-reactive with the molten material during the printing, the gas flow system being configured such that the flow of the gas flowing in at least a portion of the gas flow system has no more than about five parts-per million of water by volume.

3. The apparatus of claim 2, wherein the gas flow system is configured to provide the flow of the gas such that the water vapor is incorporated with the at least one non-reactive gas as part of the flow of the gas, and wherein at least a portion of the water vapor is from one or more of (I) the powder bed, (II) an external environment to the apparatus, (III) internal walls contacting the flow of the gas, (IV) components within the internal volume, and (V) a channel.

4. The apparatus of claim 1, wherein the one or more controllers are configured to direct the gas flow system such that the flow of the gas further modifies a concentration of gas-borne debris within the internal volume.

5. The apparatus of claim 1, wherein the location is at most about five centimeters from the one or more outlet openings.

6. (canceled)

7. (canceled)

8. The apparatus of claim 1, wherein the downstream from the one or more outlet openings is in relation to a direction of the flow of the gas.

9. The apparatus of claim 1, wherein the location is within the conduit upstream of one or more filters.

10. The apparatus of claim 1, wherein the one or more controllers are configured to direct the gas flow system to provide the flow of the gas comprising the water vapor at a concentration that facilitates incorporation of oxygen within a titanium alloy when the three-dimensional object comprises the titanium alloy.

11. The apparatus of claim 9, wherein the titanium alloy comprises (i) alpha titanium, or (ii) aluminum and vanadium.

12. (canceled)

13. The apparatus of claim 11, wherein the titanium alloy comprises a Ti—6Al—4V alloy.

14. The apparatus of claim 1, further comprising a temperature adjustment element that is configured to adjust a temperature of the powder bed, the temperature adjustment element being disposed in a build module coupled with the processing chamber during the printing.

15. The apparatus of claim 1, wherein the one or more controllers are configured to direct the flow of the gas at the exposed surface of the powder bed.

16. The apparatus of claim 1, wherein the one or more controllers are configured to direct the flow of the gas parallel, or substantially parallel, to the exposed surface of the powder bed.

17. The apparatus of claim 1, wherein during the printing, the apparatus is configured to print at least about one (1) cubic centimeters of the molten material per hour.

18. (canceled)

19. The apparatus of claim 1, wherein the one or more controllers are configured to direct the gas flow system to cause a turbulent movement of gas within the internal volume of the processing chamber.

20. The apparatus of claim 1, wherein the one or more controllers are configured to direct the gas flow system to provide the flow of the gas at a constant velocity, or at a substantially constant velocity, within the processing chamber during at least melting of the at least the portion of the powder bed.

21. The apparatus of claim 1, wherein the one or more outlet openings are operatively coupled with, or comprise: a perforated plate, a screen, a mesh, or a gas permeable material.

22. The apparatus of claim 1, wherein the one or more controllers are configured to direct the gas flow system to provide the flow of the gas having a peak horizontal velocity at a distance of from about 15 millimeters to about 100 millimeters (mm) the flow of the gas being above the exposed surface of the powder bed with respect to a gravity vector of an ambient environment external to the apparatus, the distance being a height from the exposed surface of the powder bed.

23. The apparatus of claim 1, wherein the one or more inlet openings are part of an inlet region coupled with a ceiling wall of the processing chamber, and wherein the one or more outlet openings are part of an outlet region coupled with a side wall or a floor of the processing chamber, the at least one wall comprising the ceiling wall, the side wall, and the floor.

24. The apparatus of claim 1, wherein the one or more inlet openings are part of an inlet region coupled with a first side wall of the processing chamber, and wherein the one or more outlet openings are part of an outlet region coupled with a second side wall of the processing chamber, the at least one wall comprising the first side wall and the second side wall.

25. The apparatus of claim 1, wherein the laser is configured to generate the laser beam having an average power density ranging from about 100 Kilowatt per centimeter squared (kW/cm²) to about 30,000 kW/cm², the power density being measured at the exposed surface of the powder bed.

26. The apparatus of claim 1, wherein the one or more controllers are configured to direct the gas flow system to provide a pressure of the atmosphere of the internal volume that is equal to, or substantially equal to, a pressure of an ambient atmosphere external to the processing chamber.

27. The apparatus of claim 1, wherein the one or more controllers are configured to direct the gas flow system to provide a pressure of the atmosphere of the internal volume ranging from about an ambient pressure to about 50 kilopascal (kPa) above the ambient pressure, the ambient pressure being a pressure of an ambient atmosphere external to the processing chamber.

28. The apparatus of claim 1, wherein the one or more controllers are configured to direct the gas flow system to provide a pressure of the atmosphere of the internal volume ranging from about 50 kilopascal (kPa) below an ambient pressure to the ambient pressure, the ambient pressure being a pressure of an ambient atmosphere external to the processing chamber.

29. (canceled)

30. The apparatus of claim 1, wherein the conduit is part of, or is operatively coupled with, a gas recycling system.

31. The apparatus of claim 1, wherein the layer forming device comprises a blade or a roller.

32. The apparatus of claim 1, wherein the concentration of the water vapor is sufficient to incorporate oxygen into the three-dimensional object.

33. The apparatus of claim 1, wherein the layer forming device is configured to translate reversibly in the first direction and in a direction opposing the first direction.

34. The apparatus of claim 20, wherein the one or more controllers are configured to direct the gas flow system to provide the flow of the gas at a velocity ranging from about 0.2 meters per second (m/s) to about 2 m/s.

35. A method of three-dimensional printing, the method comprising: providing the apparatus of claim 1; and using the apparatus to print the three-dimensional object.

36. Non-transitory computer readable program instructions, the program instructions, when read by one or more processors, cause the one or more processors to execute operations comprising utilizing, or directing utilization of, the apparatus of claim 1 for the printing of the three-dimensional object, the program instructions being inscribed in at least one non-transitory computer readable medium.
